(19) United States
(12) Patent Application Publication
(10) Pub. No.: US 2015/0256832 A1
(43) Pub. Date: Sep. 10, 2015

(54) APPARATUSES AND METHODS FOR PERFORMING VIDEO QUANTIZATION RATE DISTORTION CALCULATIONS

(71) Applicant: Magnum Semiconductor, Inc., Milpitas, CA (US)

(72) Inventors: Eric C. Pearson, Conestogo (CA); Pavel Novotny, Waterloo (CA)

(73) Assignee: Magnum Semiconductor, Inc., Milpitas, CA (US)

(21) Appl. No.: 14/201,492

(22) Filed: Mar. 7, 2014

(51) Int. Cl. H04N 19/124; H04N 19/147; H04N 19/186; H04N 19/176

(52) U.S. Cl. CPC H04N 19/124; H04N 19/176; H04N 19/147; H04N 19/186

(57) ABSTRACT

Examples of methods and apparatuses for performing video quantization rate distortion calculations are described herein. An example apparatus may include an encoder configured to encode a macroblock of a frame. The encoder including a rate-distortion (RD) calculator configured to individually quantize a set of coefficient blocks using each of a subset of a plurality of quantization parameter (QP) values to provide individual sets of quantized coefficient blocks. Each of the individual sets of coefficient blocks is based on data of the macroblock. The RD calculator is further configured to determine individual accumulated rate and accumulated distortion value pairs for each of the plurality of QP values based on the individual sets of quantized coefficient blocks. The RD calculator further including a mode decision block configured to receive the individual accumulated rate and accumulated distortion value pairs and to generate a RD cost-QP curve based on the individual accumulated rate and accumulated distortion value pairs. The mode decision block further configured to select a QP value during encoding of the macroblock based on the RD cost-QP curve.

### TECHNICAL FIELD

Embodiments described relate to video encoding, and examples include performing rate-distortion calculations.

### BACKGROUND

Typically, signals, such as audio or video signals, may be digitally encoded for transmission to a receiving device. Video signals may contain data that is broken up in frames over time. Due to high bandwidth requirements, baseband video signals are typically compressed by using video encoders prior to transmission/storage. Video encoders may employ a coding methodology to encode macroblocks within a frame using one or more coding modes. In many video encoding standards, such as MPEG-1, MPEG-2, MPEG-4, H.261, H.262, H.263, H.264, etc., a macroblock denotes a square region of pixels, which may be, for example, 16×16 pixels in size. Most of the coding processes (e.g. motion compensation, mode decision, quantization decision, etc.) occur at this level.

In HEVC, the concept of macroblock is extended to a block size referred as a coding unit. This disclosure uses the term macroblock to represent a coding unit. Macroblocks may be 16×16 pixels in size or alternatively, other size units of video data may be processed in the manner discussed herein for “macroblocks.” A quantization parameter (QP) may be utilized by an encoder to quantize blocks of coefficients representing video data. QP accordingly may affect the rate and distortion achieved by the coding methodology. Generally, the more quantization that is used, the lower the rate needed to transmit the data, but the higher the distortion may be due to the information lost in the quantization process. The coding methodology may select a quantization parameter (QP) value and a coding mode based on a balance of a desired quality (e.g., amount of distortion) of the encoded macroblock versus a bandwidth cost (e.g., bit rate) to transmit the encoded macroblock, commonly referred to as rate-distortion (RD) optimization.

Calculating a RD cost for each available QP value using traditional methods may introduce latency in the encoding process that exceeds maximum latency specified by encoding standards.

### BRIEF DESCRIPTION OF THE DRAWINGS

FIG. 1 is a block diagram of an encoding system with video quantization rate-distortion cost calculation according to an embodiment of the disclosure;

FIG. 2 is a schematic block diagram of an encoding system with video quantization rate-distortion cost calculation according to an embodiment of the disclosure;

FIG. 3 is a schematic block diagram of a rate-distortion cost calculator according to an embodiment of the disclosure;

FIG. 4 is a schematic block diagram of a rate-distortion calculation unit according to an embodiment of the disclosure;

FIG. 5 is a schematic block diagram of a multi-rate calculator according to an embodiment of the disclosure;

FIG. 6 is a schematic block diagram of a multi-distortion calculator according to an embodiment of the disclosure;

FIG. 7 is a schematic illustration of a media delivery system according to an embodiment of the invention; and

FIG. 8 is a schematic illustration of a video distribution system that may make use of encoders described herein.

### DETAILED DESCRIPTION

Examples of methods and apparatuses for performing video quantization rate distortion calculations are described herein. Certain details are set forth below to provide a sufficient understanding of embodiments of the disclosure. However, it will be clear to one having skill in the art that embodiments of the disclosure may be practiced without these particular details, or with additional or different details. Moreover, the particular embodiments described herein are provided by way of example and should not be used to limit the scope of the disclosure to these particular embodiments. In other instances, well-known video components, encoder or decoder components, circuits, control signals, timing protocols, and software operations have not been shown in detail in order to avoid unnecessarily obscuring the disclosure.

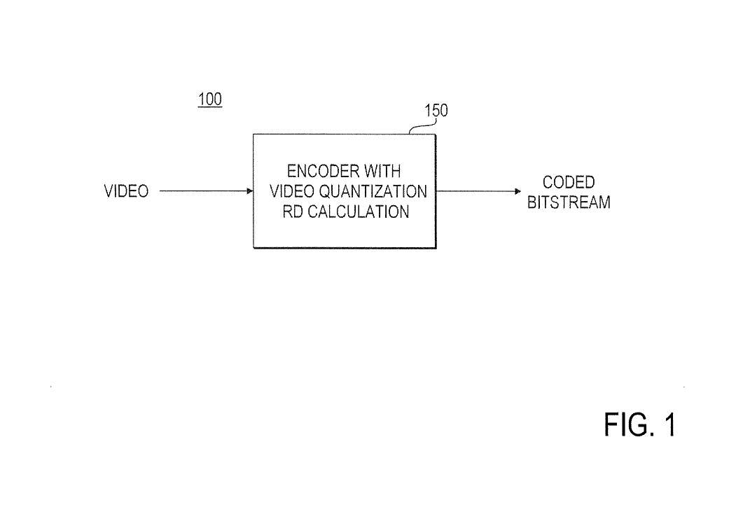

FIG. 1 is a block diagram of an encoding system 100 according to an embodiment of the disclosure. The encoding system 100, which may be implemented in hardware, software, firmware, or combinations thereof, may include an encoder with video quantization rate-distortion (RD) calculator 150 that may include control logic, logic gates, processors, memory, and/or any combination or sub-combination of the same, and may be configured to encode and/or compress a video signal to produce a coded bit-stream signal using one or more encoding techniques, examples of which will be described further below. The encoder 150 may determine an individual rate and distortion value pair associated with encoding a macroblock for each of a plurality of quantization parameter (QP) values by quantizing coefficient blocks associated with the macroblock using a subset of the plurality of QP values. The encoder 150 may use the individual rate and distortion value pairs to generate a RD cost-QP curve for selection of a QP value. Calculating individual rate and distortion values pairs for each of the plurality of QP values by only quantizing coefficient blocks using a subset of the plurality of QP values may create a complete RD cost-QP curve in less time than it takes to individually quantize the coefficient blocks for each QP value. So, for example, a RD cost-QP curve may be generated by calculating a rate and distortion value pair for selected QP values. Additional rate and distortion value pairs may then be generated using, for example, a known relationship between RD cost and increasing QP value.

The encoder 150 may be implemented in any of a variety of devices employing video encoding, including, but not limited to, televisions, broadcast systems, mobile devices, and both laptop and desktop computers. In at least one embodiment, the encoder 150 may include an entropy encoder, such as a variable-length coding encoder (e.g., Huffman encoder, context-adaptive variable length coding (CAVLC) encoder, or context-adaptive binary arithmetic coding (CABAC) encoder), and/or may be configured to encode data, for instance, at a macroblock level. Each macroblock may be encoded in intra-coded mode, inter-coded mode, bidirectionally, or in any combination or subcombination of the same.

As an example, the encoder 150 may receive and encode a video signal that, in one embodiment, may include video data (e.g., frames). The video signal may be encoded in accordance with one or more encoding standards, such as MPEG-2, MPEG-4, H.263, H.264, and/or HEVC, to provide the encoded bitstream. The encoded bitstream may be provided to a data bus and/or to a device, such as a decoder or transcoder (not shown). A video signal may be encoded by the encoder 150 using one of a plurality of QP values. Selection of the one of a plurality of QP values may be based on optimizing a total cost of encoding a current macroblock using a particular QP value.

Encoding of macroblocks within a frame may be based on a QP value selection process that is based on a particular rate-distortion trade-off, e.g., where a sufficient rate is maintained with an allowable amount of distortion. The QP value selection process, which may be performed by the encoder 150, may include quantizing coefficient blocks associated with a macroblock using a subset of a plurality of QP values, and for each of the subset of the plurality of QP values, determining RD costs using a RD cost function. The coefficient blocks may include both luma and chroma data of the macroblock as input. The RD cost to encode the macroblock associated with a QP value may be represented by a weighting factor λ, or lambda, multiplied by the rate and the product added to the distortion, e.g.:

Cost=λR+D

where R represents the rate (number of bits to encode the macroblock) and D the distortion. The distortion may be calculated using any of a variety of known distortion calculation techniques. The lambda value may be selected based on the QP value. In some embodiments, the cost function may use a lambda inverse, e.g., Costₐₗₜ=λ^{-i*}D+R.

To select a QP value used to encode a macroblock, the encoder 150 may determine an individual rate and distortion value pair associated with encoding the macroblock for each of the plurality of QP values. The encoder 150 may generate a RD cost-QP curve based on the rate and distortion value pairs, and select a QP value associated with a lowest RD cost. The encoder 150 may quantize coefficient blocks associated with the macroblock using a subset of the QP values to produce a respective set of quantized coefficient blocks associated with each of the subset of QP values. Coefficient values of the quantized coefficient blocks may have a relationship across QP values that may allow the rate and distortion value pairs for additional QP values to be derived from coefficient blocks that are quantized using an initial QP value. For example, quantized coefficient values may double with each step increase in QP values. The step size at which the quantized coefficient values double may be dependent on an implementation or coding standard. In some examples (e.g., H.264 and/or MPEG-2), the step size may be 6 such that when the QP value increases by 6, the quantized coefficient value may be double that of the quantized coefficient value of the original QP. For each respective set of quantized coefficient blocks, the encoder 150 may determine a rate and distortion value pair for each coefficient associated with the initial QP value used to generate the quantized coefficient, and additional rate and distortion value pairs may be derived for QP values equal to a multiple of the step in QP values at which the coefficients values double. Other relationships (e.g. a step size in which QP values triple, quadruple, etc.) may also be used. Leveraging the known relationship between QP value increase and coefficient value may allow for streamlined rate-distortion cost calculations. For example, the rate-distortion cost may only be calculated for QP values over a range equal to a step. For example, where the step size is 6, coefficients may be calculated for QP values of 0, 1, 2, 3, 4, and 5. Coefficient values for multiples of 6 (e.g. 6, 12, 18, etc.) may be calculated by simply doubling coefficient values calculated using the QP value of 0.

In an exemplary, non-limiting example, the step size at which the coefficients double may be 6. Accordingly, the encoder 150 may quantize the coefficient blocks using QP values 0-5 to produce six sets of quantized coefficient blocks. For each set of quantized coefficient blocks, the encoder 150 may determine accumulated rate and distortion value pairs for each coefficient associated with the initial QP value used to quantize the block of coefficients, and individual accumulated rate and distortion value pairs associated with QP values that are multiples of 6 greater than the initial QP value. That is, for quantized coefficient blocks generated using a QP value of 0, rate and distortion value pairs for each coefficient may be determine for QP values of 0, 6, 12, 18, etc.; for quantized coefficient blocks generated using a QP value of 1, rate and distortion value pairs for each coefficient may be determine for QP values of 1, 7, 13, 19, etc.

An accumulated rate and distortion value pair for each QP value is determined by accumulating the corresponding rate values and distortion values, respectively, for each coefficient of the quantized coefficient blocks. The accumulated rate and distortion pairs may be used to generate a RD cost-QP curve, which may be used to select a QP value. Thus, a RD cost-QP curve may be generated without having to independently quantize coefficient blocks for each QP value. Generating the rate and distortion value pairs for each of the plurality of QP values may provide a RD costs-QP curve, which may be complete, and that improves reliability and reduces likelihood of an erroneous QP value selection as compared with using interpolation generate the RD cost-QP curve based on a few rate and distortion value pairs. Further, by only quantizing the coefficient blocks for a subset of QP values, the individual rate and distortion value pairs may be determined for each of the plurality of QP values without exceeding latency limitations.

One of skill in the art would recognize that the step size at which the quantized coefficients double may be greater or less than 6. Additionally, one of skill in the art would also recognize that the step size may be based on another quantized coefficient/QP value function, such as when the quantized coefficients triple or quadruple. In some examples, the range of QP values is from 0-71.

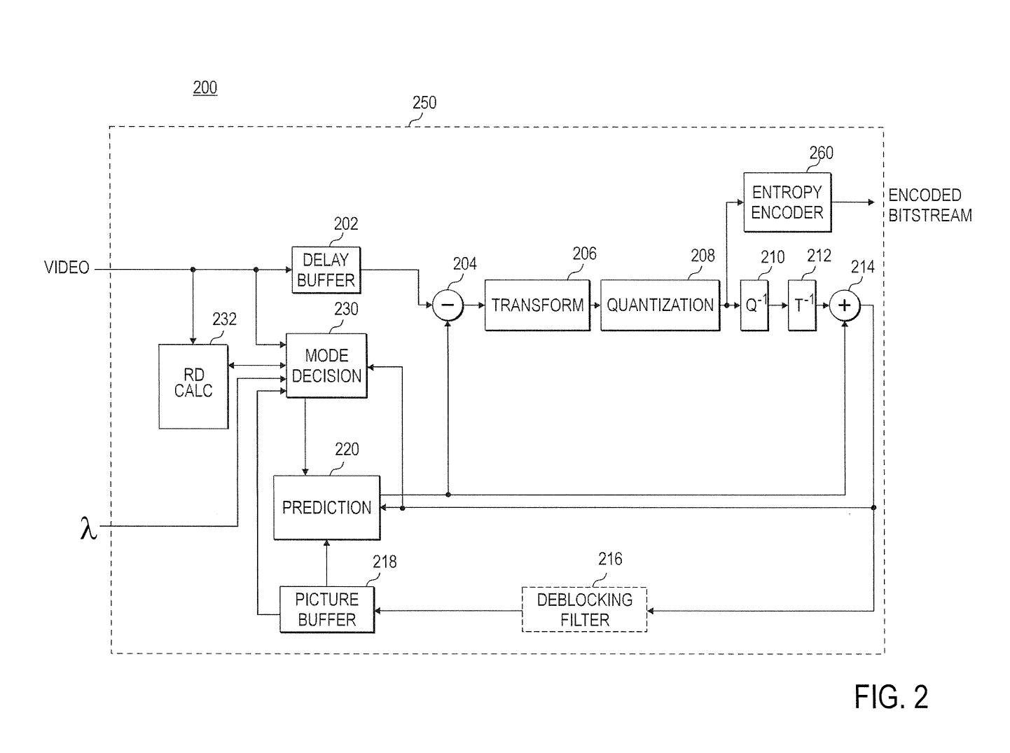

FIG. 2 is a schematic block diagram of an encoding system 200 according to an embodiment of the disclosure. The encoding system 200 may include an encoder with video quantization RD cost calculation 250, which may be implemented using the encoder 150 of FIG. 1, and may operate in accordance with one or more encoding standards in the art, known now or in the future. The encoder 250 may be implemented in semiconductor technology, and may be implemented in hardware, software, or combinations thereof.

The encoder 250 may include an encoding path having a RD calculator 232, a mode decision block 230, a delay buffer 202, a transform 206, a quantizer 208, and an entropy encoder 260. The RD calculator 232 may determine individual accumulated rate and distortion value pairs for each of a plurality of QP values. In some embodiments, the plurality of QP values may be provided by the quantizer 208. The RD calculator 232 may determine the individual accumulated rate and distortion value pair associated with encoding a macroblock for each of a plurality of quantization parameter (QP) values by quantizing coefficient blocks associated with the macroblock using a subset of the plurality of QP values. The RD calculator 232 may provide the individual accumulated rate and distortion value pairs associated with each of the plurality of QP values to the mode decision block 230.

The mode decision block 230 may select a coding mode based on a QP value and/or lambda value. The mode decision block 230 may generate a RD costs-QP curve based on the individual accumulated rate and distortion value pairs associated with each of the plurality of QP values provided by the RD calculator. The mode decision block 230 may select the QP value and/or the lambda value using the RD cost-QP curve. Available coding modes may be applied on a per frame, slice, and/or macroblock basis. The coding modes may include, but are not limited to, intra-modes, inter-modes and/or skip/direct modes. Each of these modes may further involve a selection of a set of motion vectors (out of plurality of motion vectors provided by the motion estimation block).

The output of the mode decision block 230 may be utilized by a prediction module 220 to generate a predictor in accordance with H.264 normative methods, MPEG-2 normative methods, or other prediction techniques. The predictor may be subtracted from a delayed version of the video signal at the subtractor 204. Using the delayed version of the video signal may provide time for the mode decision block 230 to act. The output of the subtractor 204 may be a residual, e.g. the difference between a macroblock and its prediction.

The transform 206 may be configured to perform a transform, such as a discrete cosine transform (DCT), on the residual to produce a set of blocks of coefficients (typically by processing the residual in blocks of 8×8 pixels or 4×4 pixels) that may, for instance, correspond to spectral components of data in the video signal. Generally, the transform 206 may transform the residual to a frequency domain representation of the residual referred to as a set of coefficient blocks.

The quantization block 208 may be configured to receive the coefficient block and quantize the coefficients of the coefficient block to produce a quantized coefficient block based on a selected QP value. The quantization provided by the quantization block 208 may be lossy and/or may also utilize a weighting factor (lambda) to adjust and/or optimize rate-distortion tradeoff for one or more coefficients of the coefficient block. Lambda may be received from the mode decision block 230, may be specified by a user, or may be provided by another element of the encoder 250. The QP value and/or lambda may be adjusted for each macroblock or for any other unit, and may be based on information encoded by the encoder 250 (e.g., video signals encoding advertising may utilize a generally larger lambda or smaller lambda inverse than video signals encoding detailed scenes). Lambda may also be common to the mode decision block 230 and the quantization block 208 (e.g. the same parameter may be used for rate-distortion optimization of the coding mode and rate-distortion optimization of the quantized coefficients).

The entropy encoder 260 may encode the quantized coefficient block with an encoding technique, such as CAVLC. The entropy encoder 260 may receive syntax elements (e.g., quantized coefficients, differential motion vectors, macroblock modes, etc.) from other devices of the macroblock encoder 250, such as the quantizer 208 and/or prediction module 220. The entropy encoder 260 may be any entropy encoder known by those having ordinary skill in the art or hereafter developed, such as a variable length coding (VLC) encoder or a binary arithmetic coding encoder (e.g. CABAC).

In some embodiments, the encoder 250 may operate in accordance with the MPEG-2 video coding standard and the H.264 video coding standard. Thus, because the MPEG-2 and the H.264 video coding standards employ motion prediction and/or compensation, the encoder 250 may further include a feedback path that includes an inverse quantizer 210, an inverse transform 212, a reconstruction adder 214, and a deblocking filter 216. These elements may mirror elements included in a decoder (not shown) that is configured to reverse, at least in part, the encoding process performed by the encoder 250. Additionally, the feedback loop of the encoder may include a decoded picture buffer 218 and the prediction block 220.

The quantized coefficient block may be inverse quantized by the inverse quantizer (Q⁻¹) 210 to provide recovered coefficients, and the recovered coefficients for a macroblock may be inverse transformed by the inverse transform (T⁻¹) 212 to produce a reconstructed macroblock residual. The reconstructed residual may be added to the predictor at the reconstruction adder 214 and after combining with the remaining reconstructed macroblocks produce reconstructed video frame, which may be deblocked by the deblocking filter 216, written to the decoded picture buffer 218 for use for prediction in encoding subsequent frames, and fed back to the macroblock prediction module 220 and to the mode decision block 230 for further in-macroblock intra prediction or other mode decision methodologies. In some examples, the deblocking filter may be removed or bypassed, and the reconstructed video frame may be provided directly to the decoded picture buffer 218 from the reconstruction adder 214.

In an example operation of the encoder 250, a video signal (e.g., a base band video signal) may be provided to the encoder 250. The video signal may be provided to the delay buffer 202, the RD calculator 232, and the mode decision block 230. The RD calculator 232 may provide individual RD costs to encode a macroblock for each of a plurality of QP values to the mode decision block 230. The mode decision block 230 may select a coding mode, which is provided to the prediction module 220. The prediction module 220 may provide a motion prediction. The subtractor 204 may receive the video signal from the delay buffer 202 and may subtract the motion prediction from the video signal to generate a residual. The residual may be provided to the transform 206 and processed using a forward transform, such as a DCT. The transform 206 may generate a coefficient block that may be provided to the quantizer 208, and the quantizer 208 may quantize the coefficient block. Quantized coefficients and other syntax elements may be provided to the entropy encoder 260 and encoded into an encoded bitstream.

The block of quantized coefficients may be inverse quantized, inverse transformed, and added to the motion prediction signal by the inverse quantization block 210, the inverse transform 212, and the reconstruction adder 214, respectively, to produce a reconstructed video signal. Both the prediction block 220 and the deblocking filter 216 may receive the reconstructed video signal, and the decoded picture buffer 218 may receive a filtered video signal from the deblocking filter 216 or the reconstructed video signal directly from the reconstruction adder 214. Based on the reconstructed and filtered video signals, the prediction block 220 may provide a motion prediction signal to the adder.

A mode decision for a current macroblock of a frame may be made by the mode decision block 230 based on a RD cost-QP curve generated based on QP and lambda combinations. The mode decision block 230 may generate the RD cost-QP curve based on the individual accumulated rate and distortion value pairs from the RD calculator. The RD calculator 232 may receive a block of pixels associated with the macroblock, including chroma and luma data. In some embodiments, the RD calculator 232 may apply a discrete cosine (DC) offset to (e.g., subtract a DC offset from) the block of pixels to, for example, remove high frequency coefficients. The RD calculator 232 may apply an N×N transform (e.g., 8×8, 4×4, 16×16, etc.) to the offset block of pixels, to produce transformed coefficient blocks. The RD calculator 232 may apply weighting to the transformed coefficient blocks to normalize the transformed coefficient blocks to produce normalized coefficient blocks.

The RD calculator 232 may calculate individual rate and distortion value pairs associated with encoding the macroblock for each of a plurality of QP values by quantizing the normalized coefficient blocks using a subset of the plurality of QP values to produce individual sets of quantized coefficient blocks. The quantized coefficient blocks may be examined (e.g. a residual generated using the quantized coefficient blocks may be compared to the predictor) to calculate distortion at the QP value used. A rate may be calculated based on the number of bits used in the quantized coefficient block. As previously described, the quantized coefficients may double (or have another predetermined relationship) with every step increase in QP values. For example, assuming a step increase of 6 results the quantized coefficient values doubling, the RD calculator 232 may forward quantize the normalized coefficient blocks using QP values 0-5 to produce 6 sets of quantized coefficient blocks. For each set of quantized coefficient blocks, rate and distortion calculations are applied to each coefficient to determine a rate and distortion value pair associated with the coefficient for an initial QP used to generate the quantized coefficient blocks (e.g., one of QP values 0-5) and for QP values that are equal to a multiple of 6 greater than the initial QP value (e.g., if initial QP is 0, then additional QP values are 6, 12, 18, 24, etc.). The respective rate values associated with each coefficient of the quantized block of coefficients for a QP value are accumulated to produce an accumulated rate value associated with the QP value. Likewise, the respective distortion values associated with each coefficient of the quantized block of coefficients for a QP value are accumulated to produce an accumulated distortion value associated with the QP value. If the range of QP values is 0-71, then 12 rate and distortion value pairs may be produced from each of the 6 sets of quantized coefficient blocks. The rate and distortion value pairs may be provided to the mode decision block 230, which may generate a RD cost-QP curve that may be used to select a QP value and/or a lambda value.

In some examples, the RD calculator 232 may additionally accumulate rates values and distortion values across an entire frame for each QP value. In some embodiments, the RD calculator 232 may use the encoding (e.g., mode decision block 230, prediction block 220, subtractor 204, transform 206, and quantizer 208), and decoding components (e.g., inverse quantizer 210 inverse transform 212, picture buffer 218, and deblocking filter 216) of the encoder 250 to determine the rate and distortion values. In other embodiments, the RD calculator 232 may include encoding and decoding components that are similar to or approximate the encoding and decoding components of the encoder 250 to generate the quantized blocks of coefficients and determine the rate and distortion values.

The above example is provided for illustrative purposes, and is not intended to limit the disclosure. One having ordinary skill in the art would recognize that the subset of QP values include be greater or less than 6 QP values, and the step size may be greater or less than 6. Additionally, the 0-71 QP values are exemplary, and may include different QP values and a total number of QP values may be greater or less than 72 values. Additionally, the luma and chroma data may be quantized individually and rate and distortion values may be accumulated individually for each of these types of data.

In some embodiments, the RD calculator 232 may calculate rate values based on an actual codec rate of the encoder 250 as measured by entropy encoding the bits. In other embodiments, the rate may be an estimation implemented as part of a trellis or rate calculation hardware built into a quantizer 208. Similarly, the RD calculator 232 may calculate distortion values based on a comparison between the reconstructed and original video signal in the spatial domain, or based on calculations in the frequency domain as part of the quantization process. The RD calculator 232 may be implemented using quantizers associated with an unused codec on the same device. In some embodiments, the quantizers and inverse quantizers may be modified to allow direct control of the quantizers and inverse quantizers to control forward quantizer and quantizer scaling.

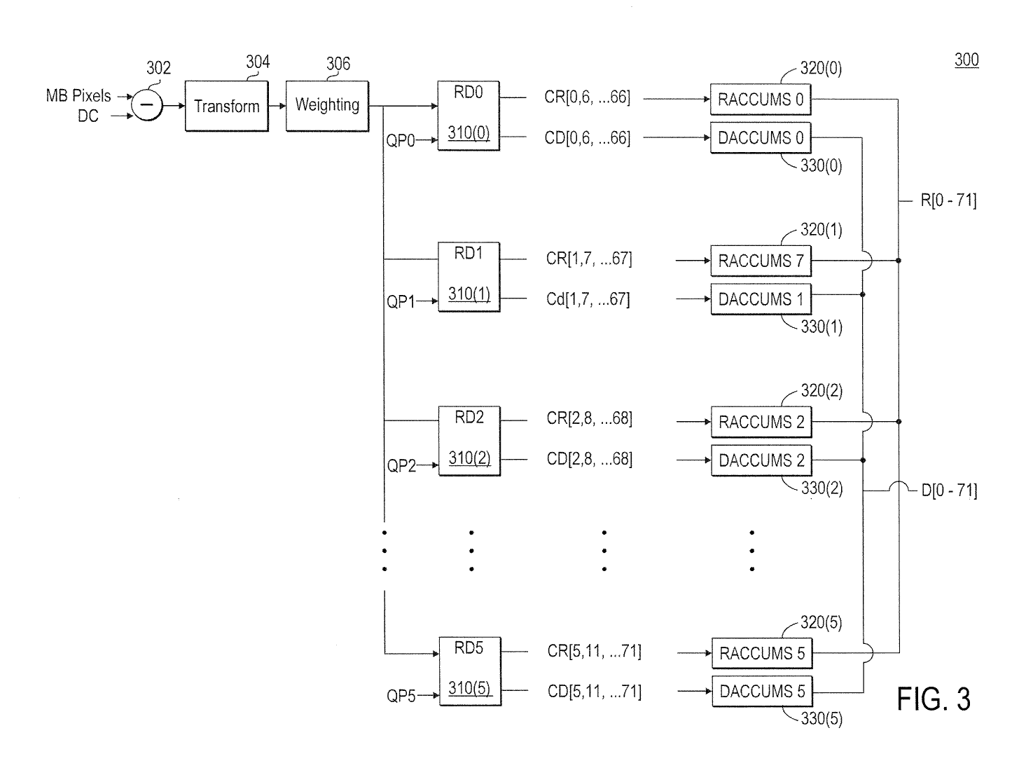

FIG. 3 is a schematic block diagram of a video quantization rate-distortion cost calculator 300 according to an embodiment of the disclosure. The video quantization rate distortion calculator 300 may include a subtractor 302, a transform 304, and a weight module 306 to condition a received block of pixels associated with a macroblock for consumption by each of the rate-distortion units RD units 310(0-5). The RD units 310(0-5) may provide rate values to respective rate accumulators 320(0-5) and distortion values to respective distortion accumulators 330(0-5). The video quantization rate distortion calculator 300 may be used to implement the RD calculator 232 of FIG. 2, and may operate in accordance with one or more encoding standards in the art, known now or in the future. The video quantization rate distortion calculator 300 may be implemented in semiconductor technology, and may be implemented in hardware, software, or combinations thereof.

As previously described, the subtractor 302, transform 304, and weight module 306 may condition the block of pixels of the macroblock for the RD units 310(0-5). The subtractor 302 may receive the block of pixels of the macroblock, including luma and chroma data. The subtractor 302 may subtract a DC offset from the block of pixels to, for example, remove low frequency coefficients. The transform 304 may apply an N×N transform (e.g., 8×8, 4×4, 16×16, etc.) to the block of coefficients, to produce transformed coefficient blocks. The weight module 306 may apply weighting to the transformed coefficient blocks to normalize the coefficient blocks to produce normalized coefficient blocks.

Each of the RD units 310(0-5) may quantize the normalized coefficient blocks using one of QP values (0-5 in the example of FIG. 3) to provide a respective set of quantized coefficient blocks. The RD units 310(0-5) may further generate rate and distortion value pairs associated with each of an initial QP value (e.g., one of QP values 0-5) and QP values equal to a multiple of 6 greater than the initial QP value for each coefficient of the set of quantized coefficient blocks. For example, for each coefficient of a respective set of coefficient blocks, the RD unit 310(0) may determine rate and distortion value pairs associated with QP values of 0, 6, 12, etc.; the RD unit 310(1) may determine rate and distortion value pairs for QP values of 1, 7, 13, etc.; the RD unit 310(2) may determine rate and distortion value pairs for QP values of 2, 8, 14, etc. Each of the RD units 310(0-5) may include a lossless forward quantizer to quantize the normalized coefficient blocks to produce the respective set of quantized coefficient blocks. In some embodiments, the set of quantized coefficient blocks may include the luma coefficient block and a chroma coefficient block. Each of the RD units 310(0-5) may further include a multi-rate and a multi-distortion calculator that are configured to determine rate values and distortion values, respectively, for each coefficient of the set of quantized coefficient blocks for each assigned QP value. Each coefficient rate value CR[0-71] is provided to respective rate accumulators 320(0-5) and each coefficient distortion value CD[0-71] is provided to a respective distortion accumulator 330(0-5).

The rate accumulators 320(0-5) may, for a given QP value, accumulate rate values for each coefficient of the respective set of coefficient blocks to provide an accumulated rate R[0-71] for that QP value. For example, the rate accumulators 320(0) may accumulate the rate values for each coefficient of the set of quantized coefficient blocks associated with the QP value of 0 to provide the accumulated rate value R[0]. Similarly, the rate accumulators 320(0) may accumulate the rate values for each coefficient of the set of quantized coefficient blocks associated with the QP value of 6 to provide the accumulated rate value R[6]. Combined, the rate accumulators 320(0-5) provide the accumulated rate values R[0-71] associated with each of the QP values 0-71.

The distortion accumulators 330(0-5) may, for a given QP value, accumulate distortion values for each coefficient of the respective set of coefficient blocks to provide an accumulated distortion D[0-71] for that QP value. For example, the distortion accumulators 330(0) may accumulate the distortion values for each coefficient of the set of quantized coefficient blocks associated with the QP value of 0 to provide the accumulated distortion value R[0]. Similarly, the distortion accumulators 330(0) may accumulate the distortion values for each coefficient of the set of quantized coefficient blocks associated with the QP value of 6 to provide the accumulated distortion value D[6]. Combined, the distortion accumulators 330(0-5) provide the accumulated distortion values D[0-71] associated with each of the QP values 0-71.

In an example operation, the subtractor 302 may receive a block of pixels associated with the macroblock, including chroma and luma data. The subtractor 302 may subtract a DC offset from the block of pixels to, for example, remove low frequency coefficients. In some embodiments, the subtractor 302 is not included, and the block of pixels is provided directly to the transform 304. The transform 304 may apply an N×N transform (e.g., 8×8, 4×4, 16×16, etc.) to the offset block of pixels, to produce transformed coefficient blocks. The weight module 306 may apply weighting to the transformed coefficient blocks to normalize the transformed coefficient blocks to produce normalized coefficient blocks. The normalized coefficient blocks may be provided to each of the RD units 310(0-5).

Each of the RD units 310(0-5) may receive a respective QP value 0-5, and may forward quantize the normalized coefficient blocks in a lossless manner using the respective QP value 0-5 to provide a respective set of quantized coefficient blocks. As previously described the values of coefficients of the set of quantized coefficient blocks may double with every step increase of 6 in QP values. Thus, for each set of quantized coefficient blocks, rate and distortion calculations are applied to each coefficient to determine a rate CR[0-71] and distortion CD[0-71] value pairs associated with the coefficient for an initial QP value (e.g., one of QP values 0-5) used to generate the respective set of quantized coefficient blocks and QP values that are equal to a multiple of 6 greater than the initial QP value (e.g., if initial QP is 0, then additional QP values are 6, 12, 18, 24, etc.). If the range of QP values is 0-71, then each of the RD units 310(0-5) may provide 12 rate and distortion value pairs for each coefficient of the respective set of quantized coefficient blocks.

The rate accumulators 320(0-5) may receive the rate values CR[0-71] generated by the respective RD units 310(0-5) for each coefficient and QP value combination. Each of the rate accumulators 320(0-5) may accumulate the rate values CR[0-71] associated with a QP value for each coefficient of the respective set of quantized coefficient blocks to produce a respective accumulated rate value R[0-71] associated with the QP value. In some embodiments, the rate accumulators 320(0-5) may accumulate rate values over a frame to provide a frame rate associated with each QP value.

The distortion accumulators 330(0-5) may receive the distortion values CD[0-71] generated by the respective RD units 310(0-5) for each coefficient and QP value combination. Each of the distortion accumulators 330(0-5) may accumulate the distortion values CD[0-71] associated with a QP value for each coefficient of the respective set of quantized coefficient blocks to produce a respective accumulated distortion value D[0-71] associated with the QP value. In some embodiments, the distortion accumulators 330(0-5) may accumulate distortion values over a frame to provide a frame distortion value associated with each QP value.

The rate R[0-71] and distortion D[0-71] value pairs may be provided to the mode decision block, such as the mode decision block 230 of FIG. 2, to generate a RD cost-QP curve for selection of a QP value used to encode the macroblock. In some embodiments, each of the RD units 310(0-5) may use the encoding, and decoding components of an installed encoder to determine the rate and distortion values. In other embodiments, each of the RD units 310(0-5) may include encoding and decoding components that are similar to or approximate the encoding and decoding components of the installed encoder to generate the sets of quantized coefficient blocks and determine the rate and distortion values.

Note that although rates and distortions may be accumulated for all coding units, such as a frame, for all possible QP values in FIG. 3, the coefficients need only be quantized by an encoder a number of times equal to the number of QP values within a step size. In the example of FIG. 3, the step size is 6 (e.g. the quantized coefficient values have a particular relationship when the QP value is increased by 6, such as double). Accordingly, in FIG. 3, an encoder need only quantize the coefficients using 6 QP values, but nonetheless rate-distortion pairs may be identified for all possible QP values.

The above example is provided for illustrative purposes, and is not intended to limit the disclosure. One having ordinary skill in the art would recognize that more or fewer than 6 RD units 310(0-5) may be included, and a number of RD units and rate and distortion accumulators may be based on the step size and/or a number of QP values. Additionally, the 0-71 QP values are exemplary, and may include different QP values and a total number of QP values may be greater or less than 72 values.

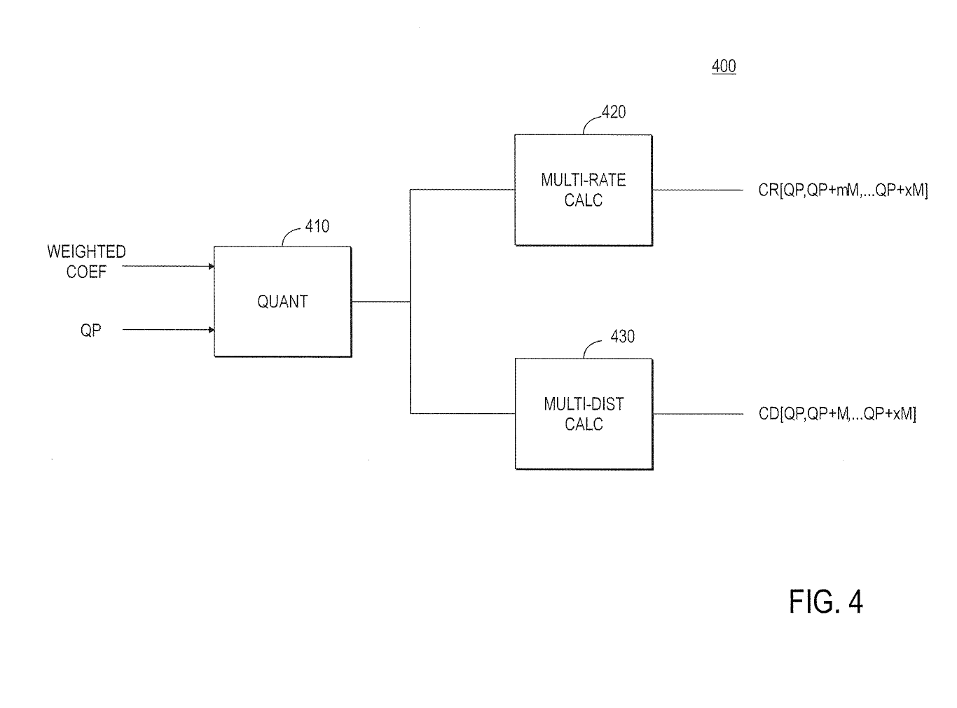

FIG. 4 is a schematic block diagram of a rate-distortion calculation unit 400 according to an embodiment of the disclosure. The rate-distortion calculation unit 400 may include a quantizer 410 that quantizes a weighted coefficient based on a received QP value to produce a quantized coefficient, and provides the quantized coefficient to each of the multi-rate calculator 420 and multi-distortion calculator 430. The quantizer 410 may be a lossless forward quantizer. The multi-rate calculator 420 may provide individual coefficient rate values associated with a subset of QP values at an output. The multi-distortion calculator 430 may provide individual coefficient distortion values associated with a subset of QP values at an output. The rate-distortion calculation unit 400 may be used to implement each of the RD units 310(0-5) of FIG. 3, and may operate in accordance with one or more encoding standards in the art, known now or in the future. The rate-distortion calculation unit 400 may be implemented in semiconductor technology, and may be implemented in hardware, software, or combinations thereof.

In an example operation, the quantizer 410 may receive the QP value and the weighted coefficient, and provide the quantized coefficient. The multi-rate calculator 420 may perform multiple rate calculations to provide individual coefficient rate values CR[QP, QP+M, . . . QP+xM] associated with a subset of QP values (e.g., QP, QP+M, . . . QP+xM), where QP is an initial QP value, M is a step size at which a quantized coefficient doubles, and x is an integer. In the previously described examples, M is equal to 6 and x is equal to 11. The multi-distortion calculator 430 may perform multiple rate calculations to provide individual coefficient rate values CD[QP, QP+M, . . . QP+xM] associated with a subset of QP values (e.g., QP, QP+M, . . . QP+xM). The multi-rate calculator 420 may provide the coefficient rate values CR[QP, QP+M, . . . QP+xM] to a respective rate accumulator, such as one of the rate accumulators 320(0-5) of FIG. 3. The multi-distortion calculator 430 may provide the coefficient distortion values CD[QP, QP+M, . . . QP+xM] to a respective distortion accumulator, such as one of the distortion accumulators 330(0-5) of FIG. 3.

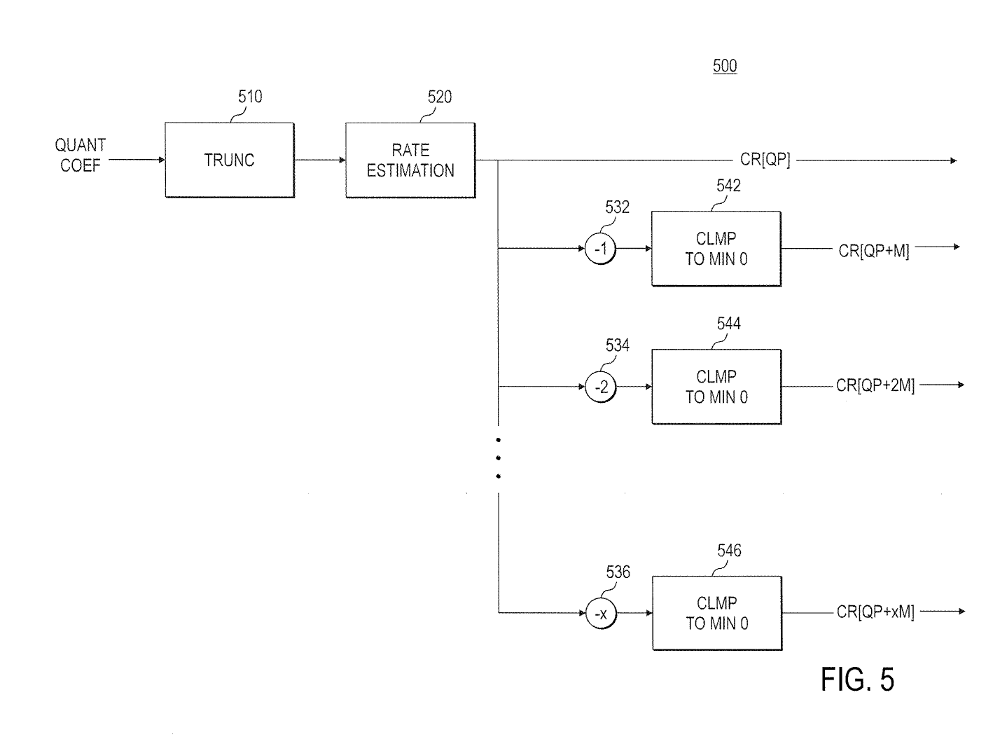

FIG. 5 is a schematic block diagram of a multi-rate calculator 500 according to an embodiment of the disclosure. The multi-rate calculator 500 may include a truncation module 510 that truncates a fractional component from the quantized coefficient and provides the truncated quantize coefficient to a rate estimator 520. The rate estimator 520 may provide a rate estimation to subtractors 532, 534, and 536. The subtractors 532, 534, and 536 may reduce the bit rate estimation by a specified amount (e.g., 532=1 bit, 534=2 bits, and 536=11 bits). Once subtracted, the values may be clamped to zero at clamps including the clamps 542, 544, and 546 to prevent negative rate values. The coefficient rates are provided at the output of the clamps CR[QP, QP+M, QP+2M, . . . QP+xM], where QP is an initial QP value, M is a step size at which a quantized coefficient doubles (or has some other predetermined relationship), and x is an integer. The multi-rate calculator 500 may be used to implement the multi-rate calculator 420 of FIG. 4, and may operate in accordance with one or more encoding standards in the art, known now or in the future.

In an example operation, the truncation module 510 may receive the quantized coefficient. The quantized coefficient may include an integer component and a fractional component. The truncation module 510 may truncate the fractional component, leaving only the integer component. Rate values may become smaller as the QP values increase, reducing the significance of the fractional component in determining a coefficient rate.

The rate estimator 520 may receive the truncated quantized coefficient. As previously described, as QP increases, rate decreases. Generally, a rate is equal to 0 when a quantized coefficient is 0. Otherwise, the rate is a number of bits necessary to encode the quantized coefficient includes a sign bit plus a number of bits required to encode an absolute value of the truncated quantized coefficient in binary. A rate value for a quantized coefficient has a base-2 logarithmic relationship with rate values of the same coefficient quantized using other QP values. The rate for a quantized coefficient (QC) may be calculated as follows:

CR(QC)=(QC==0)?0:CEIL(LOG₂(ABS(QC)))+1

An alternative example QC rate calculation may be:

CR(QC)=(QC==0)?0:CEIL(LOG₂(ABS(QC−1)))*2+1

As is shown in the above equations, the coefficient rates have a logarithmic relationship. In some embodiments, a size of the quantized coefficient may decrease by half with every M increase in QP value (e.g., 6 in the previous examples). Based on the halving relationship, the rate for a quantized coefficient quantized using an initial QP plus M will cost one less bit to encode than a quantized coefficient quantized using the initial QP value. Therefore, once an initial coefficient rate CR[QP] associated with an initial QP value is determined by the truncation module 510, coefficient rates CR[QP+M, QP+2M, . . . QP+xM] associated with QP values equal to multiples of M greater than the initial QP value may be derived by subtracting bits of the initial coefficient rate CR[QP] to by one bit for every multiple M that the QP value is greater than the initial QP value. Thus, the subtractor 532 may subtract 1 bit from the estimated rate because the associated QP value is QP+M, the subtractor 534 may subtract 2 from the_estimated rate because the associated QP value is QP+2*M, and the subtractor 536 may subtract x bits from the initial estimated rate because the associated QP value is QP+x*M. In some embodiments, x is equal to 11. Once the values are subtracted, the clamps 542, 544, and 546 may clamp the reduced rates to zero to ensure that the CR[QP, QP+M, QP+2M, . . . QP+xM] provided at the output are non-negative values. As previously described, M may be greater or less than 6, and x may be greater or less than 11. It will also be understood that additional subtractors may be used to generate additional CR values between QP+2*m and QP+x*M. Additionally, the relationships between the rates and QP values may be different than described, such as quartering with every step increase.

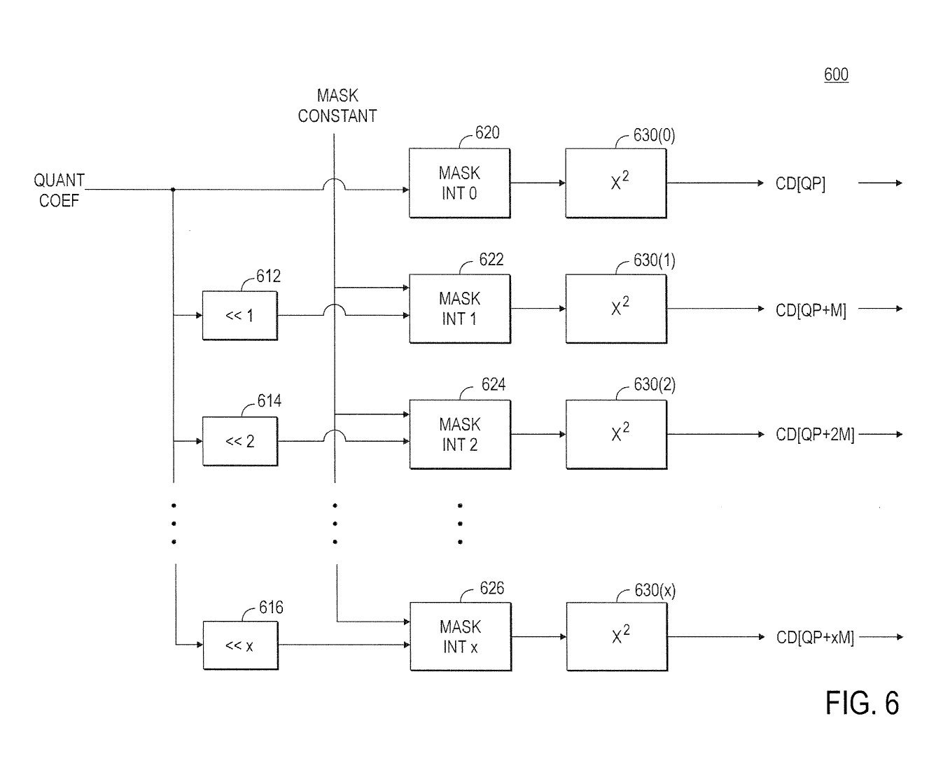

FIG. 6 is a schematic block diagram of a multi-distortion calculator 600 according to an embodiment of the disclosure. The multi-distortion calculator 600 may receive a quantized coefficient and provide the quantized coefficient, left-shifted by a certain number of bits via left shifters 612, 614, and 616 in some instances, to respective mask modules 620, 622, 624, and 626. The respective masks may extract a fixed precision fractional component of the quantized coefficient representing an error induced by the quantization process. The extracted fixed precision fractional component may be squared by the squaring modules 630(0-x) to provide the coefficient distortion values CD[QP, QP+M, . . . QP+xM]. The multi-distortion calculator 600 may be used to implement the multi-distortion calculator 430 of FIG. 4, and may operate in accordance with one or more encoding standards in the art, known now or in the future.

In an example operation, the mask module 620 may receive the quantized coefficient directly, and the mask modules 622, the 624, and the 626 may receive the quantized coefficient after it has been left-shifted by the left shifters 612, 614, and 616, respectively, by 1, 2, and x bits, respectively. As the QP values increase, the distortion (e.g., error) introduced during the quantization process increases. Based on the step relationship between QP values and quantized coefficients generated using an initial QP value, distortions for QP values equal to a multiple of M (e.g., M is equal to 6) greater than the initial QP may be determined by left shifting a quantized coefficient prior to masking the quantized coefficient. As previously described, the mask modules 620, 622, 624, and 626 may bitwise AND a mask with the (left-shifted) quantized coefficient to extract the fixed precision fractional component of the quantized coefficient representing an error induced by the quantization process. The coefficient distortion CD[QP, QP+M, . . . QP+xM] may be determined by squaring the extracted error induced by the quantization process at the squaring modules 630(0-x). When the quantized coefficient is generated from a normalized coefficient block, the number of bits to represent the distortion may be fixed for all QP values. Otherwise, the number of bits to represent the distortion may increase as the QP value increases.

FIGS. 5 and 6 depict exemplary multi-rate 500 and multi-distortion 600 calculators, respectively, and are non-limiting. Other designs may be used to implement the multi-rate and multi-distortion calculators described in the disclosure.

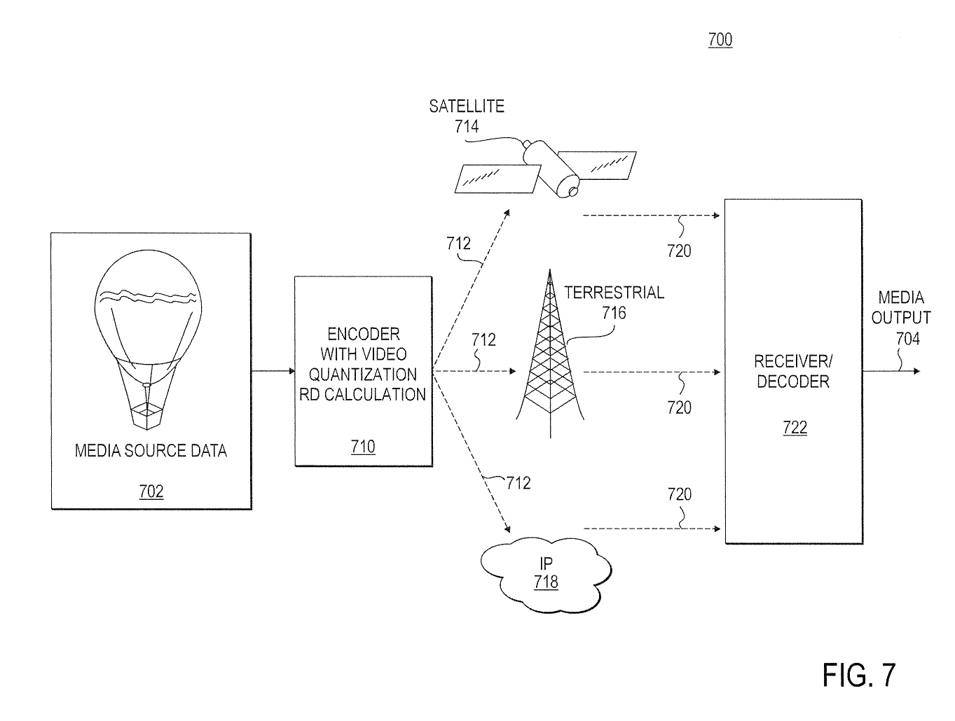

FIG. 7 is a schematic illustration of a media delivery system in accordance with embodiments. The media delivery system 700 may provide a mechanism for delivering a media source 702 to one or more of a variety of media output(s) 704. Although only one media source 702 and media output 704 are illustrated in FIG. 7, it is to be understood that any number may be used, and examples may be used to broadcast and/or otherwise deliver media content to any number of media outputs.

The media source data 702 may be any source of media content, including but not limited to, video, audio, data, or combinations thereof. The media source data 702 may be, for example, audio and/or video data that may be captured using a camera, microphone, and/or other capturing devices, or may be generated or provided by a processing device. Media source data 702 may be analog or digital. When the media source data 702 is analog data, the media source data 702 may be converted to digital data using, for example, an analog-to-digital converter (ADC). Typically, to transmit the media source data 702, some type of compression and/or encryption may be desirable. Accordingly, an encoder with joint rate-distortion optimization 710 may be provided that may encode the media source data 702 using any encoding method in the art, known now or in the future, including encoding methods in accordance with video standards such as, but not limited to, MPEG-2, MPEG-4, H.264, HEVC, or combinations of these or other encoding standards. The encoder with video quantization rate-distortion (RD) calculator (encoder) 710 may be implemented using any encoder described herein, including the encoder 150 of FIG. 1 and the encoder 250 of FIG. 2, the video quantization rate distortion calculator 300 of FIG. 3, the rate-distortion calculation unit 400 of FIG. 4, the multi-rate calculator 500 of FIG. 5, and/or the multi-distortion calculator 600 of FIG. 6.

The encoded data 712 may be provided to a communications link, such as a satellite 714, an antenna 716, and/or a network 718. The network 718 may be wired or wireless, and further may communicate using electrical and/or optical transmission. The antenna 716 may be a terrestrial antenna, and may, for example, receive and transmit conventional AM and FM signals, satellite signals, or other signals known in the art. The communications link may broadcast the encoded data 712, and in some examples may alter the encoded data 712 and broadcast the altered encoded data 712 (e.g., by re-encoding, adding to, or subtracting from the encoded data 712). The encoded data 720 provided from the communications link may be received by a receiver 722 that may include or be coupled to a decoder. The decoder may decode the encoded data 720 to provide one or more media outputs, with the media output 704 shown in FIG. 7.

The receiver 722 may be included in or in communication with any number of devices, including but not limited to a modem, router, server, set-top box, laptop, desktop, computer, tablet, mobile phone, etc.

The media delivery system 700 of FIG. 7 and/or the encoder with joint rate-distortion optimization 610 may be utilized in a variety of segments of a content distribution industry.

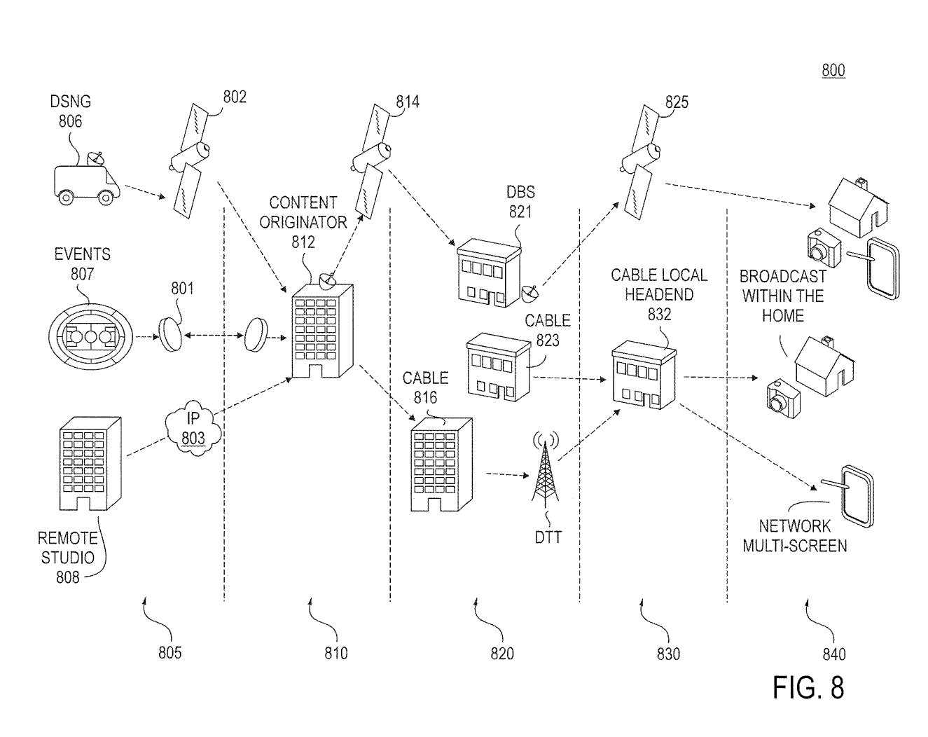

FIG. 8 is a schematic illustration of a video distribution system that 800 may make use of encoders described herein. The video distribution system 800 includes video contributors 805. The video contributors 805 may include, but are not limited to, digital satellite news gathering systems 806, event broadcasts 807, and remote studios 808. Each or any of these video contributors 805 may utilize an encoder described herein, such as the encoder 710 of FIG. 7, to encode media source data and provide encoded data to a communications link. The digital satellite news gathering system 806 may provide encoded data to a satellite 802. The event broadcast 807 may provide encoded data to an antenna 801. The remote studio 808 may provide encoded data over a network 803.

A production segment 810 may include a content originator 812. The content originator 812 may receive encoded data from any or combinations of the video contributors 805. The content originator 812 may make the received content available, and may edit, combine, and/or manipulate any of the received content to make the content available. The content originator 812 may utilize encoders described herein, such as the encoder 710 of FIG. 7, to provide encoded data to the satellite 814 (or another communications link). The content originator 812 may provide encoded data to a digital terrestrial television system 816 over a network or other communication link. In some examples, the content originator 812 may utilize a decoder to decode the content received from the contributor(s) 805. The content originator 812 may then re-encode data; potentially utilizing encoders described herein, such as the encoder 710 of FIG. 7, and provide the encoded data to the satellite 814. In other examples, the content originator 812 may not decode the received data, and may utilize a transcoder (which may include an encoder 710) to change an encoding format of the received data.

A primary distribution segment 820 may include a digital broadcast system 821, the digital terrestrial television system 816, and/or a cable system 823. The digital broadcasting system 821 may include a receiver, such as the receiver 722 described with reference to FIG. 7, to receive encoded data from the satellite 814. The digital terrestrial television system 816 may include a receiver, such as the receiver 722 described with reference to FIG. 7, to receive encoded data from the content originator 812. The cable system 823 may host its own content which may or may not have been received from the production segment 810 and/or the contributor segment 805. For example, the cable system 823 may provide its own media source data 702 as that which was described with reference to FIG. 7.

The digital broadcast system 821 may include an encoder, such as the encoder 710 described with reference to FIG. 7, to provide encoded data to the satellite 825. The cable system 823 may include an encoder, such as the encoder 710 described with reference to FIG. 7, to provide encoded data over a network or other communications link to a cable local headend 832. A secondary distribution segment 830 may include, for example, the satellite 825 and/or the cable local headend 832.

The cable local headend 832 may include an encoder, such as the encoder 710 described with reference to FIG. 7, to provide encoded data to clients in a client segment 840 over a network or other communications link. The satellite 825 may broadcast signals to clients in the client segment 840. The client segment 840 may include any number of devices that may include receivers, such as the receiver 722 and associated decoder described with reference to FIG. 7, for decoding content, and ultimately, making content available to users. The client segment 840 may include devices such as set-top boxes, tablets, computers, servers, laptops, desktops, cell phones, etc.

Accordingly, encoding, transcoding, and/or decoding may be utilized at any of a number of points in a video distribution system. Embodiments may find use within any, or in some examples all, of these segments.

From the foregoing it will be appreciated that, although specific embodiments of the disclosure have been described herein for purposes of illustration, various modifications may be made without deviating from the spirit and scope of the disclosure. Accordingly, the disclosure is not limited except as by the appended claims.

What is claimed is:

1. An encoding system, comprising:
an encoder configured to encode a macroblock of a frame, the encoder comprising:
a rate-distortion (RD) calculator configured to individually quantize a set of coefficient blocks using each of a subset of a plurality of quantization parameter (QP) values to provide individual sets of quantized coefficient blocks, wherein each of the individual sets of coefficient blocks is based on data of the macroblock, the RD calculator further configured to determine individual accumulated rate and accumulated distortion value pairs for each of the plurality of QP values based on the individual sets of quantized coefficient blocks; and
a mode decision block configured to receive the individual accumulated rate and accumulated distortion value pairs and to generate a RD cost-QP curve based on the individual accumulated rate and accumulated distortion value pairs, the mode decision block further configured to select a QP value used during encoding of the macroblock based on the RD cost-QP curve.

2. The encoding system of claim 1, wherein a set of quantized coefficient blocks of the individual sets of quantized coefficient blocks is quantized using an initial QP value of the subset of QP values and includes a plurality of quantized coefficients, wherein the RD calculator comprises a RD calculation unit configured to generate, for the initial QP value, first respective individual coefficient rate values and first respective individual coefficient distortion values for each quantized coefficient of the plurality of quantized coefficients, the RD calculation unit further configured to generate, for a second QP value that is equal to a step value greater than the initial QP value, second respective individual coefficient rate values and second respective individual coefficient distortion values for each coefficient of the plurality of coefficients, wherein the step value is equal to a count of QP values in the subset of QP values.

3. The encoding system of claim 2, wherein the RD calculation unit comprises a quantizer configured to quantize a coefficient of the set of coefficient blocks using the initial QP value to produce a quantized coefficient of the plurality of quantized coefficients, the RD calculation unit further comprising a multi-rate calculator configured to generate a first coefficient rate value for the quantized coefficient for the initial QP value and to generate a second coefficient rate value for the quantized coefficient for the second QP value, wherein the first coefficient rate value is included in the first respective individual coefficient rate values and the second coefficient rate value is included in the second respective individual coefficient rate values.

4. The encoding system of claim 3, wherein the multi-rate calculator comprises a truncation module configured to truncate the quantized coefficient to remove a fractional component of the quantized coefficient, the multi-rate calculator further comprising a rate estimator configured to provide the first coefficient rate value based on the truncated quantized coefficient, the multi-rate calculator further comprising a bit subtractor configured to subtract a bit of the first coefficient rate value to provide the second coefficient rate value, the multi-rate calculator further configured to clamp the second coefficient rate value to zero when the second coefficient rate value is less than zero.

5. The encoding system of claim 3, wherein the RD calculation unit comprises a multi-distortion calculator configured to generate a first coefficient distortion value for the quantized coefficient for the initial QP value and to generate a second coefficient distortion value for the quantized coefficient for the second QP value, wherein the first coefficient distortion value is included in the first respective individual coefficient distortion values and the second coefficient distortion value is included in the second respective individual coefficient distortion values.

6. The encoding system of claim 5, wherein the multi-distortion calculator comprises a first mask module configured to extract a first quantization error from the quantized coefficient and a first squaring module configured to square the first quantization error to provide the first coefficient distortion value, the multi-rate calculator further comprising a bit shifter configured to shift the bits of the quantized coefficient, the multi-distortion calculator further comprising a second mask module configured to extract a second quantization error from the shifted quantized coefficient and a second squaring module configured to square the second quantization error to provide the second coefficient distortion value.

7. The encoding system of claim 3, wherein the quantizer is a lossless forward quantizer.

8. The encoding system of claim 2, wherein the RD calculator comprises a rate accumulator configured to accumulate the first individual coefficient rate values for each coefficient of the plurality of coefficients to produce a first accumulated rate value, the rate accumulated further configured to accumulate the second individual coefficient rate values for each coefficient of the plurality of coefficients to produce a second accumulated rate value, wherein the RD calculator further comprises a distortion accumulator configured to accumulate the first individual coefficient distortion values for each coefficient of the plurality of coefficients to produce a first accumulated distortion value, the distortion accumulated further configured to accumulate the second individual coefficient distortion values for each coefficient of the plurality of coefficients to produce a second accumulated distortion value.

9. The encoding system of claim 1, wherein the RD calculator comprises a transform configured to receive a block of pixels of the macroblock and apply an N×N transform to the block of pixels to produce a set of transformed coefficient blocks, the RD calculator further comprising a weight module configured to normalize the set of transformed coefficient blocks to provide the set of coefficient blocks.

10. The encoding system of claim 1, wherein the encoder is configured to receive a video signal, wherein the video signal includes video data, wherein the video data includes a frame including the macroblock.

11. The encoding system of claim 1, wherein the macroblock includes luma and chroma data.

12. A non-transitory computer-readable medium comprising instructions that, when executed by one or more processing units, cause the one or more processing units to:
quantize, in parallel, a set of coefficient blocks using a plurality of initial quantization parameter (QP) values of a plurality of QP values to produce respective sets of quantized coefficient blocks, wherein the set of coefficient blocks are based on data of a macroblock;
generate, for each of the respective sets of quantized coefficient blocks, respective rate and distortion value pairs for each of a corresponding initial QP value of the plurality of initial QP values and for QP values of a plurality of remaining QP values of the plurality of QP values that are integer multiples of a step size greater than the initial QP value, wherein the set size equal to a count of QP values in the plurality of initial QP values;
generate a RD cost-QP curve based on each of the respective rate and distortion value pairs; and
select a QP value from the plurality of QP values based on the RD cost-QP curve.

13. The non-transitory computer-readable medium of claim 12, further comprising instructions that, when executed by the one or more processing units, cause the one or more processing units to, for each respective rate and distortion value pair:
accumulate respective coefficient rate values for each coefficient in the respective set of coefficient for a corresponding QP value to generate an accumulated rate value associated with the corresponding QP value; and
accumulate respective coefficient distortion values for each coefficient in the respective set of coefficient for a corresponding QP value to generate a respective accumulated distortion value associated with the QP value.

14. The non-transitory computer-readable medium of claim 12, wherein the step size is based on a relationship between quantized coefficient values generated using an initial QP value of the plurality of initial QP values and quantized coefficient values generated using a QP value of the remaining plurality of QP values.

15. The non-transitory computer-readable medium of claim 14, wherein the step size is determined based on the quantized coefficient values generated using the QP value of the remaining plurality of QP values being equal to double quantized coefficient values generated using the initial QP value of the plurality of initial QP values.

16. The non-transitory computer-readable medium of claim 15, wherein the step size is 6 and wherein the initial plurality of QP values includes QP values from 0 to 5, and wherein the remaining plurality of QP values include QP values greater than 5.

17. A method, comprising:
quantizing a set of coefficient blocks using a first quantization parameter (QP) value to produce a set of quantized coefficient blocks, wherein the set of coefficient blocks are based on data of a macroblock;
generating a first rate and distortion value pair based on the quantized set of coefficient blocks for the first QP value; and
generating a second rate and distortion value pair based on the quantized set of coefficient blocks for a second QP value, wherein the second QP value is selected based on a relationship between quantized coefficient values resulting from quantizing using the first QP value and from quantizing using the second QP value.

18. The method of claim 17, wherein the step size is selected when quantized coefficient values generated by quantizing using the second QP value are twice as great as quantized coefficient values generated by quantizing using the first QP value.

19. The method of claim 18, wherein the second QP value is a multiple of 6 greater than the first QP value.

20. The method of claim 17, wherein generating the first rate and distortion value pair comprises generating first respective individual coefficient rate values and first respective individual coefficient distortion values for each quantized coefficient of the set of quantized coefficient blocks, wherein generating the second rate and distortion value pair comprises generating second respective individual coefficient rate values and second respective individual coefficient distortion values for each coefficient of the set of quantized coefficient blocks.

21. The method of claim 20, wherein generating first respective individual coefficient rate values comprises, for a quantized coefficient of the set of quantized coefficient blocks:
truncating the quantized coefficient to remove a fractional component; and
generating a rate estimate based on the truncated quantized coefficient, wherein the rate estimate is a coefficient rate value for the quantized coefficient included in the first respective individual coefficient rate values.

22. The method of claim 21, wherein generating second respective individual coefficient rate values comprises, for the quantized coefficient of the set of quantized coefficient blocks, subtracting a bit of the rate estimate to provide a second coefficient rate value, wherein the second coefficient rate value is included in the second respective individual coefficient rate values.

23. The method of claim 20, wherein generating first respective individual coefficient distortion values comprises, for a quantized coefficient of the set of quantized coefficient blocks:
extracting a quantization error from the quantized coefficient; and
squaring the extracted quantization error to provide a first coefficient distortion value included in the first respective individual coefficient distortion values.

24. The method of claim 20, wherein generating second respective individual coefficient rate values comprises, for a quantized coefficient of the set of quantized coefficient blocks:
shifting bits of the quantized coefficient to the left to provide a shifted quantized coefficient;
extracting a quantization error from the shifted quantized coefficient; and
squaring the extracted quantization error to provide a second coefficient distortion value included in the second respective individual coefficient distortion values.
